(19) United States
(12) Patent Application Publication
(10) Pub. No.: US 2005/0254742 A1
(43) Pub. Date: Nov. 17, 2005

(54) Roller bearing and manufacturing method of cage thereof

(75) Inventors: Toshinori Shibano, Kamakura-shi (JP); Toshihiro Kida, Kamakura-shi (JP)

Correspondence Address: STEINBERG & RASKIN, P.C., 1140 AVENUE OF THE AMERICAS, 15th FLOOR, NEW YORK, NY, 10036-5803, US

(73) Assignee: NIPPON THOMPSON CO., LTD., Tokyo (JP)

(21) Appl. No.: 11/113,875

(22) Filed: Apr. 25, 2005

(30) Foreign Application Priority Data
May 13, 2004 (JP) 2004-143717

(51) Int. Cl. F16C 33/54; F16C 33/46

(52) U.S. Cl. 384/580

(57) ABSTRACT

A roller bearing in which a plurality of pockets (3) parallel to an axial center line are formed in an outer peripheral surface (2) of a ring-shaped cage (1). Rollers (5) are rotatably assembled in the pockets (3), and an annular piece (7, 7) having a shape bent in an inner diametrical direction with respect to the outer peripheral surface (2) is formed in a side surface of the cage (1). A concave portion (9, 9) continuously provided in a circumferential direction of the cage (1) is formed in any one of an inner side of the outer peripheral surface (2) in the cage (1), an inner side of the annular piece (7, 7) and an inner side of a corner portion (8, 8) where they intersect, or astride any one of the inner side of the outer peripheral surface (2), the inner side of the annular piece (7, 7) and the inner side of the corner portion (8, 8) where they intersect.

### BACKGROUND OF THE INVENTION

1. Field of the Invention

The present invention relates to a roller bearing in which a needle roller is incorporated, and a manufacturing method of a cage of the roller bearing.

2. Description of the Related Art

This kind of roller bearing is formed via a process shown in FIG. 9. A target roller bearing is formed by applying a cutting process (S1) to a bar member or a pipe member, finishing the member in a desired shape in accordance with a lathe turning process (S2), and thereafter applying a notching (S3), a width grinding (S4), a heat treatment (S5), an outer periphery grinding (S6) and a surface treatment (S7). However, since the lathe turning process is high in cost, a roll forming is employed recently. Further, as a roller bearing manufactured by the roll forming, a conventional structure shown in FIGS. 7 and 8 has been known, a cage 51 in FIGS. 7 and 8 is manufactured in accordance with the roll forming. The manufacturing method is described in Japanese Patent laid-open No. 2000-205273 and is also shown in FIGS. 6A to 6C.

First, as shown in FIG. 6A, a cylindrical member 60 forming the cage 51 is set as shown in the drawing between an inner diameter roll 61 provided with a trapezoidal groove 61a in a center portion in an axial direction and an outer diameter roll 62 provided with a trapezoidal convex portion 62a corresponding to the trapezoidal groove 61a in a center portion in the axial direction. Further, both ends 60a and 60b of the cylindrical member 60 are pressed by a pair of guide rolls 63 and 63 so as to prevent the cylindrical member 60 from being shifted in the axial direction.

In the state mentioned above, the inner diameter roll 61 is rotationally driven while pressure contacting the inner diameter roll 61 with the outer diameter roll 62. As mentioned above, a trapezoidal groove portion 56 extending along trapezoidal groove 61a of the inner diameter roll 61 and the trapezoidal convex portion 62a of the outer diameter roll 62 is formed in a center portion in an axial direction of the cylindrical member 60 by pressure contacting the inner diameter roll 61 with the outer diameter roll 62.

The cylindrical member 60 in which the trapezoidal groove portion 56 is formed in the manner mentioned above is chucked within a drive chuck 64 as shown in FIG. 6B, and is firmly held by inserting an end panel roll 65 to an inner side of the cylindrical member 60 so that the cylindrical member 60 does not move within the drive chuck 64. In this state, when applying a first bending roll 66 to one end 60a of the cylindrical member 60 from an obliquely downward direction in the drawing, the one end 60a is bent at a predetermined intermediate angle, for example, about 45°.

When the one end 60a of the cylindrical member 60 is bent at the intermediate angle, a second bending roll 67 is applied to the bent portion from a downward direction in the drawing as shown in FIG. 6C, and the bending angle is made deeper to about 90°.

In the same manner, annular pieces 57 and 57 are formed by bending the other end 60b of the cylindrical member 60.

As mentioned above, the cage 51 of the roller bearing shown in FIG. 7 is manufactured by forming the trapezoidal groove portion 56 and the annular pieces 57 and 57 in the cylindrical member 60.

In the cage 51 manufactured in the manner mentioned above, a lot of pockets 53 parallel to an axis of a shaft (not shown) assembled in the cage 51 are formed in an outer peripheral surface 52 thereof, as shown in FIG. 8. Further, a holding portion 54 obtained by bending the outer peripheral surface 52 of the cage 51 is formed between the pockets 53. Further, a roller 55 is rotatably assembled in the pocket 53.

In this case, the holding portion 54 mentioned above is provided with roller loss preventing portions 54a and 54a formed by a horizontal portion having the same level as the outer peripheral surface 52, a lower stage horizontal portion 54b provided in an inner peripheral side of the roller loss preventing portions 54a and 54a, and guide surfaces 54c and 54c formed by a pair of inclined portions connecting the lower stage horizontal portion 54b and the roller loss preventing portions 54a and 54a. The trapezoidal groove portion 56 is formed by the lower stage horizontal portion 54b and the guide surfaces 54c and 54c.

The annular pieces 57 and 57 formed in a shape obtained by bending an outer peripheral edge of the cage 51 are formed in outer sides of the roller loss preventing portions 54a and 54a. Further, portions at which the roller loss preventing portions 54a and 54a intersect with the annular pieces 57 and 57 are formed as corner portions 58 and 58.

In connection with the roller bearing and the manufacturing method of the cage of the roller bearing, there are techniques described in Japanese Patent Laid-Open No. 2000-205273.

In the cage 51 of the roller bearing manufactured in the manner mentioned above, shallow circular arcs 58a and 58a are formed in the corner portions 58 and 58 as shown in FIG. 7. Because a bending stress in each of the bending processes mentioned above is concentrated on a corner portion, however, the metal can not be bent at right angles and the shallow circular arcs 58a and 58a are formed in the portion.

In the case that the roller bearing of the type in which the corner portions 58 and 58 are formed as the shallow circular arcs 58a and 58a is employed, for example, in a connecting portion of a two-stroke engine, an air-fuel mixture having a gasoline and a lubricating oil is fed to a crankcase. Accordingly, the lubrication is executed by the lubricating oil in the air-fuel mixture, and a lubricating condition becomes severe at that degree. In addition, there is a case that an oil film break is generated in a slide contact portion of the cage, a rolling contact surface or the like on the basis of a synergistic action of a severe load condition caused by a centrifugal force and an inertial force and a high temperature ambient atmosphere within an engine.

Further, if this kind of roller bearing is under the severe lubricating condition as mentioned above, an abrasion powder or the like of a piston tends to intrude into an inner portion of the bearing. If the abrasion powder intrudes into the inner portion of the bearing, there is a risk that a function as the bearing is lowered, and a service life thereof is lowered.

### SUMMARY OF THE INVENTION

An object of the present invention is to provide a roller bearing which is excellent in a lubricating performance and prevents a foreign material from being nipped, and a manufacturing method of a cage of the roller bearing.

According to a first aspect of the present invention, there is provided a roller bearing in which a lot of pockets parallel to an axial center line are formed in an outer peripheral surface of a ring-shaped cage, rollers are rotatably assembled in the pockets, and an annular piece having a shape bent in an inner diametrical direction with respect to the outer peripheral surface is formed in a side surface of the cage, wherein a concave portion continuously provided in a circumferential direction of the cage is formed in any one of an inner side of the outer peripheral surface in the cage, an inner side of the annular piece and an inner side of a corner portion where they intersect, or astride any one of the inner side of the outer peripheral surface, the inner side of the annular piece and the inner side of the corner portion where they intersect.

An intended use of the bearing according to the present invention is not particularly limited. It goes without saying that the bearing can be used in any intended use such as a two-stroke engine, a four-stroke engine, a transmission, the other industrial machine or the like.

According to a second aspect of the present invention, there is provided a method of manufacturing a cage of a roller bearing in accordance with a roll forming, wherein a process is provided with a cored bar roll arranged in an inner side of a cylindrical member and an outer diameter roll arranged in an outer side of the cylindrical member, the cored bar roll is provided with a trapezoidal groove corresponding to a trapezoidal groove portion formed in the cylindrical member and is provided with pressing corner portions in both outward sides of the trapezoidal groove, the outer diameter roll is provided with a trapezoidal convex portion corresponding to the trapezoidal groove of the cored bar roll in a center portion thereof and is provided with holding surfaces holding the cylindrical member in both outward sides of the trapezoidal convex portion, and is provided with a guide surface formed in a circular arc shape toward a bottom portion of the outer diameter roll from the holding surface, the cylindrical member pinched between the trapezoidal groove and the trapezoidal convex portion is narrowed down by narrowing down the cylindrical member held between holding surfaces of a pair of bending dies between the outer diameter roll and the cored bar roll so as to narrow down the cylindrical member, whereby a thickness in this portion is let out to an outer side and an outer side of the cylindrical member is bent along the guide surface at the pressing corner portion serving as a supporting point, and a concave portion is formed in a base end of an annular piece of the finished cage on the way that a thickness movement of the portion pinched between the trapezoidal groove and the trapezoidal convex portion moves to an outer side from the bent portion at the pressing corner portion.

### BRIEF DESCRIPTION OF THE DRAWINGS

FIG. 1A is an explanatory view of a manufacturing step showing a state in which a cylindrical member of the present invention is pinched between a cored bar roll and an outer diameter roll;

FIG. 1B is an explanatory view of a manufacturing step showing a step of bending the cylindrical member by the cored bar roll and the outer diameter roll;

FIG. 1C is an explanatory view of a manufacturing step showing a step of bending the cylindrical member by the cored bar roll and the outer diameter roll;

FIG. 1D is an explanatory view of a manufacturing step showing a state in which a trapezoidal groove portion and an annular piece are formed;

FIG. 2 is a cross sectional view showing a state in which a cage is formed in accordance with a roll forming;

FIG. 3A is a partial cross sectional view of a roller bearing according to a first embodiment;

FIG. 3B is an enlarged view of a portion I in FIG. 3A;

FIG. 4 is a partial enlarged view of a cage according to a second embodiment;

FIG. 5 is a partial enlarged view of a cage according to a third embodiment;

FIG. 6A is an explanatory view of a manufacturing step showing a state in which a conventional cylindrical member is pinched between an inner diameter roll and an outer diameter roll;

FIG. 6B is an explanatory view of a manufacturing step showing a step of bending the conventional cylindrical member by the inner diameter roll and the outer diameter roll;

FIG. 6C is an explanatory view of a manufacturing step showing a state in which a trapezoidal groove portion and an annular piece are formed in a conventional cage;

FIG. 7 is a cross sectional view showing a state in which the conventional cage is formed;

FIG. 8 is a partial cross sectional view of the conventional roller bearing; and

FIG. 9 is a view showing a conventional lathe turning process.

### DESCRIPTION OF THE PREFERRED EMBODIMENT

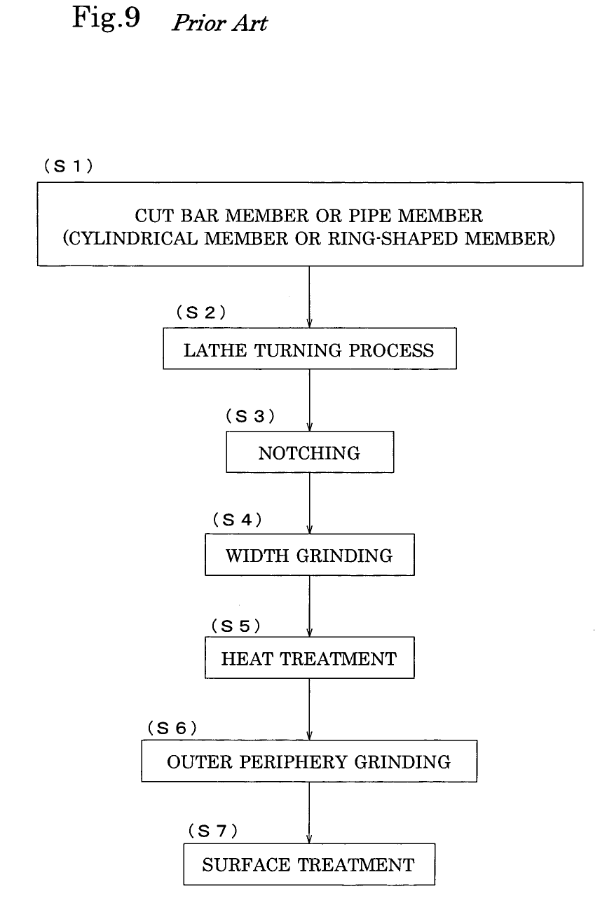

A cage 1 of a roller bearing according to an embodiment of the present invention is manufactured by a roll forming, the cage 1 is formed via absolutely the same process as the process shown in FIG. 9 except the step of the lathe turning process (S2) is changed to the roll forming.

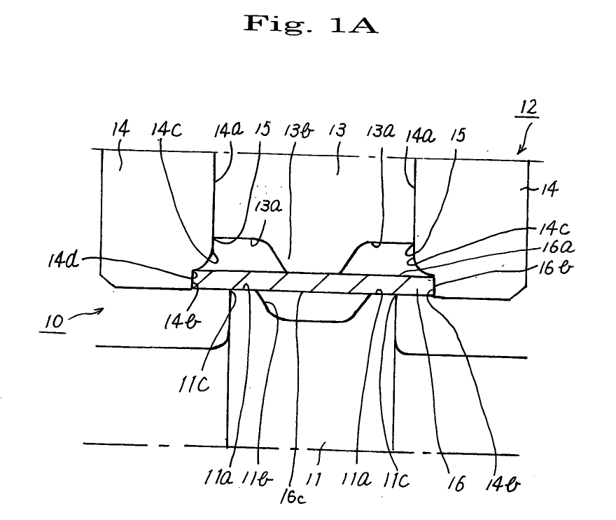

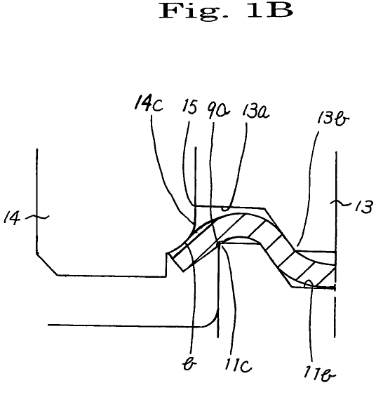

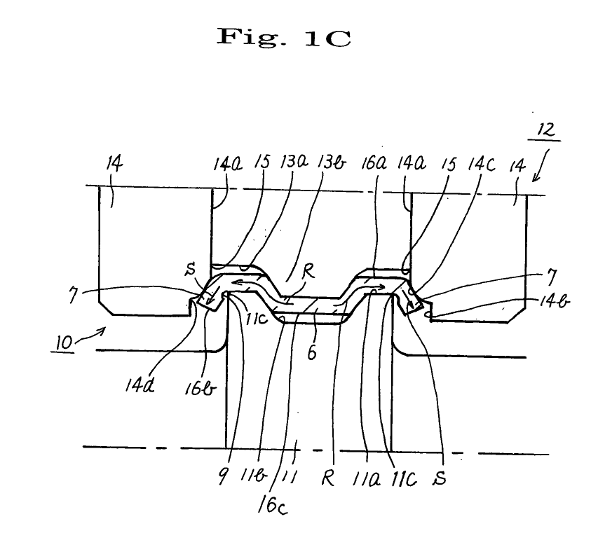

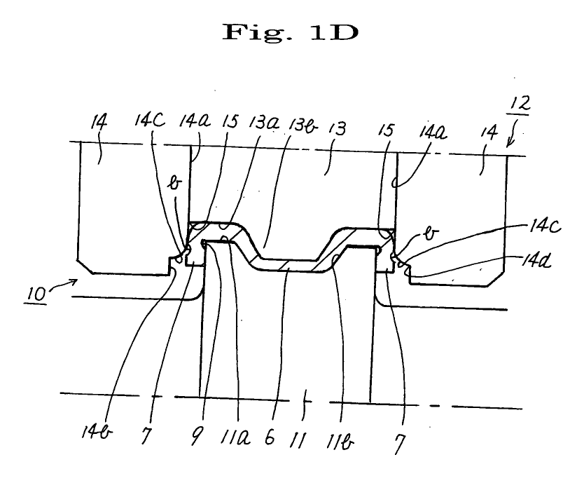

Further, a manufacturing apparatus 10 of the cage 1 mentioned above is constituted by a cored bar roll 11 and an outer diameter roll 12, as shown in FIG. 1A. The outer diameter roll 12 is structured by a forming die 13 and bending dies 14 and 14 provided in both ends of the forming die 13.

The cored bar roll 11 is structured such that pressing protruding portions 11a and 11a are formed in both ends in an axial direction thereof, and a trapezoidal groove 11b is formed by depressing between the pressing protruding portions 11a and 11a. Pressing corner portions 11c and 11c in an outer side of the pressing protruding portions 11a and 11a structured in the manner mentioned above are approximately perpendicular. Further, the forming die 13 of the outer diameter roll 12 is structured such that a trapezoidal convex portion 13b is formed by protruding a center portion in an axial direction in an outer periphery thereof, and pressing surfaces 13a and 13a provided with a step with respect to the trapezoidal convex portion 13b are formed in both sides of the trapezoidal convex portion 13b.

Further, holding surfaces 14b and 14b positioned in an outer side of the forming die 13 rather than side surfaces 14a and 14a in a side being in contact with the forming die 13 are formed in the bending dies 14 and 14 of the outer diameter roll 12. Further, the structure is made such that a cylindrical member 16 is held between the holding surfaces 14b and 14b. There is established a relation that an outer peripheral surface 16a of the cylindrical member 16 is brought into contact with a top of the trapezoidal convex portion 13b as shown in FIG. 1A, at a time when the cylindrical member 16 is held between the holding surfaces 14b and 14b.

Further, a circular arc portion is formed between the holding surfaces 14b and 14b and the side surfaces 14a and 14a, and the circular arc portion is formed as guide surfaces 14c and 14c.

Further, perpendicular portions 15 and 15 are formed by the pressing surface 13a of the forming die 13 and the side surfaces 14a and 14a of the bending dies 14 and 14.

A description will be given of a method of manufacturing the cage 1 by using the manufacturing apparatus 10 having the structure mentioned above with reference to FIGS. 1A to 1D.

First, as shown in FIG. 1A, when inserting the cylindrical member 16 forming the cage 1 into the outer diameter roll 12 in such a manner that both ends 16b and 16b are brought into contact with the holding surfaces 14b and 14b of the bending dies 14 and 14, the cylindrical member 16 is held by the holding surfaces 14b and 14b formed in the bending dies 14 and 14. As mentioned above, the outer peripheral surface 16a of the cylindrical member 16 is brought into contact with the trapezoidal convex portion 13b of the forming die 13 by holding the cylindrical member 16 by the holding surfaces 14b and 14b.

After the cylindrical member 16 is held by the outer diameter roll 12 in the manner mentioned above, the cored bar roll 11 is next inserted into the cylindrical member 16, and the trapezoidal groove 11b and the trapezoidal convex portion 13b of the molding die 13 are opposed to each other. Further, when rotating the outer diameter roll 12 while pressing the cored bar roll 11 to the inner peripheral surface 16c of the cylindrical member 16 in the side of the outer diameter roll 12, the cored bar roll 11 and the cylindrical member 16 are rotated accordingly.

When narrowing down the cylindrical member 16 by pressing the outer diameter roll 12 to the cored bar roll 11 in the manner mentioned above, the pressing corner portion 11c is first brought into contact with the cylindrical member 16 so as to bend the cylindrical member 16 around the pressing corner portion 11c serving as the supporting point. At this time, as shown in FIG. 1B, the pressing corner portion 11c bites into the cylindrical member 16 and a bite concave portion 9a is formed in the portion. At this time, an outer side of the cylindrical member 16 is pressure contacted with the guide surface 14c and a concave b is formed in the portion, however, the concave b is scraped away by a width grinding (S4) shown in FIG. 9 after the cage is finished.

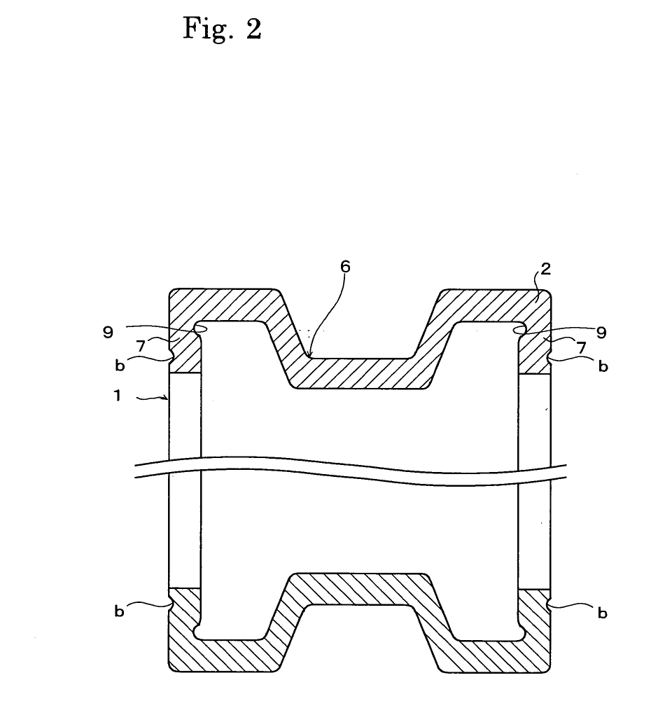

When further narrowing down the cylindrical member 16 in the state mentioned above, an amount of narrowing down of the cylindrical member 16 existing between the trapezoidal convex portion 13b and the trapezoidal groove 11b is larger than an amount of narrowing down of the end portion of the cylindrical member 16, so that a thickness of the cylindrical member 16 between the trapezoidal convex portion 13b and the trapezoidal groove 11b moves in a direction of an arrow R shown in FIG. 1C. At this time, the thickness of the end portion of the cylindrical member 16 also moves in a direction of an arrow S, however, a moving amount of the thickness at this time establishes the relation R>S on the basis of a difference of the amount of narrowing down mentioned above. The bite concave portion 9a described above is left at a time when the cage 1 is finished, as shown in FIGS. 1D and 2.

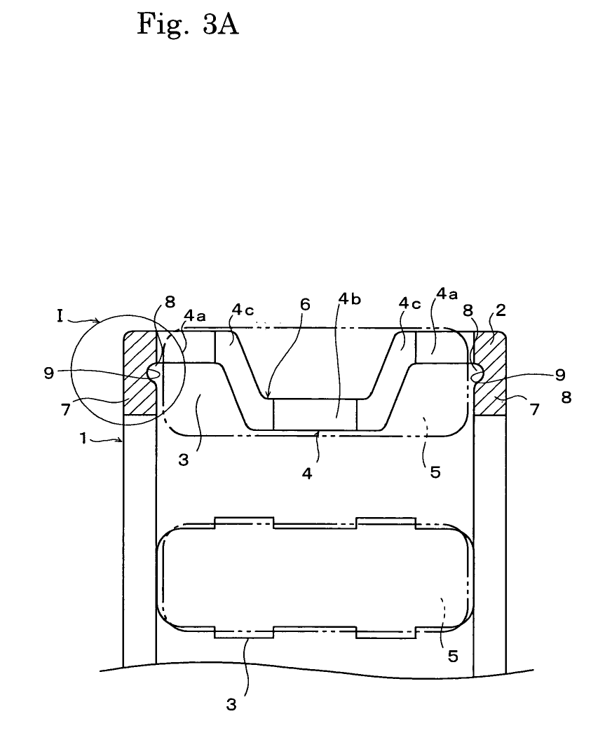

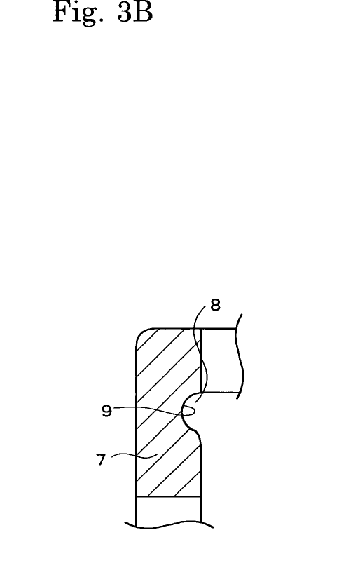

The cage 1 in accordance with the first embodiment manufactured in the manner mentioned above passes through a step S3 to a step S7 shown in FIG. 9. Further, as shown in FIG. 3A, a plurality of pockets 3 parallel to an axis of a shaft (not shown) assembled in the cage 1 are formed in the outer peripheral surface 2 of the cage 1 in accordance with an notching process. Further, a holding portion 4 obtained by bending the outer peripheral surface 2 of the cage 1 is formed between the pockets 3. Further, a roller 5 is rotatably assembled in the pocket 3.

In this case, the holding portion 4 mentioned above is provided with roller loss preventing portions 4a and 4a having the same level as the outer peripheral surface 2, a lower stage horizontal portion 4b provided in an inner peripheral side of the roller loss preventing portions 4a and 4a, and a pair of guide surfaces 4c and 4c connecting the lower stage horizontal portion 4b and the roller loss preventing portions 4a and 4a. Further, a trapezoidal groove portion 6 is formed by the lower stage horizontal portion 4b and the guide surfaces 4c and 4c.

Further, annular pieces 7 and 7 in which an outer peripheral edge of the cage 1 is formed in a bent shape are formed in outer sides of the roller loss preventing portions 4a and 4a.

Further, as shown in FIGS. 3A and 3B, concave portions 9 and 9 are formed in inner sides of the annular pieces 7 and 7 and near corner portions 8 and 8 intersecting the roller loss preventing portions 4a and 4a. In this case, a principle by which the concave portions 9 and 9 are formed is as mentioned above.

As is apparent from the description above, in order to form the concave portion 9 in the corner portion 8 of the cage 1, it is necessary to regulate a flow of the thickness, and it is accordingly necessary to apply a roll forming shown in FIGS. 1A to 1C to the cylindrical member 16.

Further, even in the case that the roller bearing having the cage 1 with the concave portion 9 is used, for example, in a connecting portion between a big end of a connecting rod and a crank pin in a two-stroke engine, no problem is generated. The reason is as follows.

For example, when the cage 1 is placed in the ambient atmosphere which is filled with the air-fuel mixture of the gasoline and the lubricating oil, the lubricating oil at that time flows into the concave portions 9 and 9. The lubricating oil flowing into the concave portions 9 and 9 is reserved in the concave portions 9 and 9. When the lubricating oil is reserved in the concave portions 9 and 9, it is possible to improve a lubricating effect with the roller end surface. Accordingly, it is possible to extend a service life of the roller bearing at that degree.

Further, in accordance with the used condition of the roller bearing, there is a case that the cage is placed in the ambient atmosphere in which the foreign material such as the abrasion powder of the metal or the like is made, as mentioned above, however, the foreign material is reserved in the concave portions 9 and 9 together with the lubricating oil and is hard to flow out to the rolling surface side of the roller 5, so that it is possible to further extend the service life of the bearing.

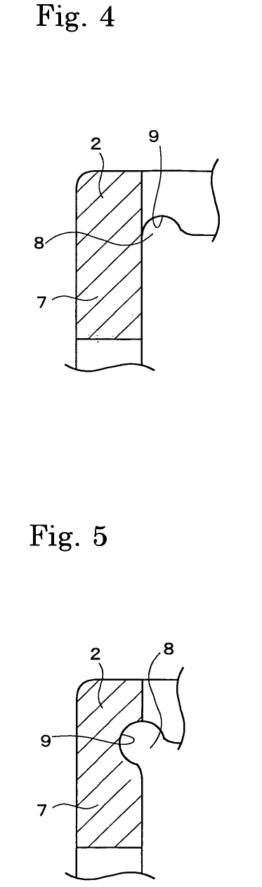

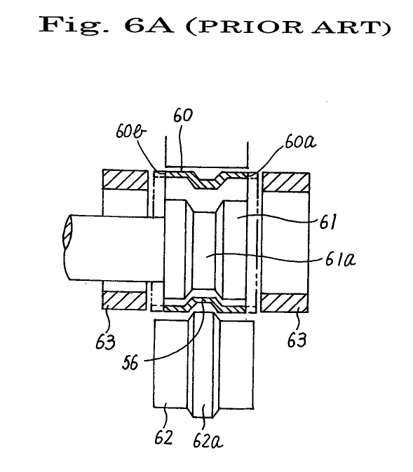

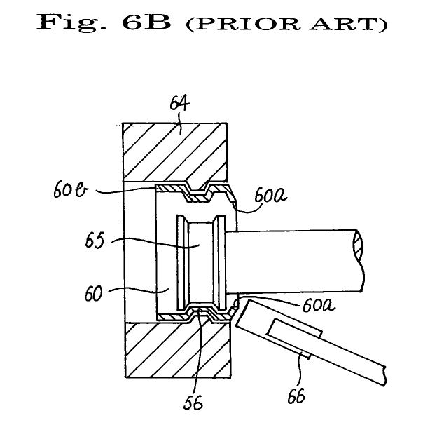

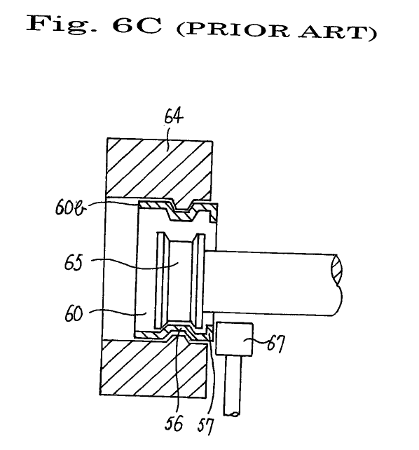

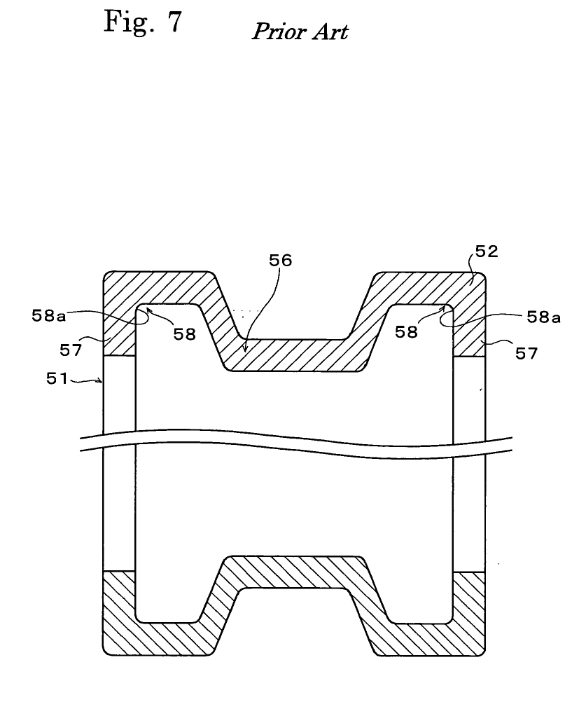

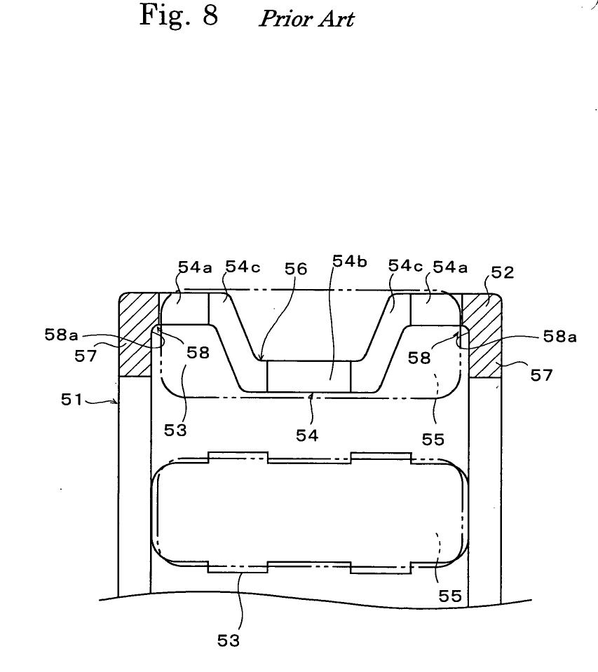

In this case, in the cage 1 according to the first embodiment manufactured on the basis of the manufacturing method mentioned above, the concave portions 9 and 9 are formed in the inner sides of the annular pieces 7 and 7 and near the corner portions 8 and 8. However, if the manufacturing step is not particularly designated, the concave portions 9 and 9 may be provided in the inner side of the outer peripheral surface 2 of the cage 1 and near the corner portions 8 and 8, as in a second embodiment shown in FIG. 4. Further, they may be provided over the inner side of the outer peripheral surface 2 of the cage 1, the inner sides of the annular pieces 7 and 7 and the corner portions 8 and 8, as in a third embodiment shown in FIG. 5. In brief, as far as the concave portions 9 and 9 are provided in the position to which the rotating force of the roller 5 is applied, the concave portions 9 and 9 may be provided in any of the inner side of the outer peripheral surface 2 of the cage 1, the inner sides of the annular pieces 7 and 7 and the corner portions 8 and 8.

According to the first invention, since the concave portion continuously provided in the circumferential direction of the cage is formed in the corner portion at which the outer peripheral surface of the cage and the annular piece intersect, the roller bearing is placed in the ambient atmosphere filled with the air-fuel mixture of the gasoline and the lubricating oil, for example, in the case that this kind of roller bearing is used in the connecting portion between the big end of the connecting rod and the crank pin of the two-stroke engine. However, at this time, the lubricating oil mentioned above is held in the concave portion. If the lubricating oil is held in the concave portion in the manner mentioned above, the lubricating effect of the roller end surface can be improved, it is possible to expect an anti-seizing effect due to a heat generation in the roller end surface, and it is possible to extend the service life of the roller bearing at that degree.

Further, in accordance with the used condition of the roller bearing, there is a case that the cage is placed in the ambient atmosphere in which the foreign material such as the abrasion powder of the metal or the like is made, as mentioned above, however, according to the first invention, the foreign material is reserved in the concave portions together with the lubricating oil and is hard to flow out to the rolling surface side of the roller, so that it is possible to eliminate an obstacle due to the foreign material.

According to the second invention, the concave portion is formed in the inner side of the annular piece by narrowing down the cylindrical member by the outer diameter roll and the cored bar roll. Accordingly, it is possible to widely reduce a cost for forming the concave portion.

1. A roller bearing in which a plurality of pockets (3) parallel to an axial center line are formed in an outer peripheral surface (2) of a tubular cage (1), rollers (5) are rotatably assembled in the pockets (3), and an annular piece (7) having a shape bent in an inner diametrical direction with respect to the outer peripheral surface (2) is formed in a side surface of the cage (1), wherein a concave portion (9) continuously provided in a circumferential direction of the cage (1) is formed in any one of an inner side of the outer peripheral surface (2) in the cage (1), an inner side of the annular piece (7) and an inner side of a corner portion (8) where they intersect, or astride any one of the inner side of the outer peripheral surface (2), the inner side of the annular piece (7) and the inner side of the corner portion (8) where they intersect.

2. A method of manufacturing a cage (1) of a roller bearing in accordance with a roll forming, wherein a process is provided with a cored bar roll (11) arranged in an inner side of a cylindrical member (16) and an outer diameter roll (12) arranged in an outer side of the cylindrical member (16), the cored bar roll (11) is provided with a trapezoidal groove (11b) corresponding to a trapezoidal groove portion (6) formed in the cylindrical member (16) and is provided with pressing corner portions (11c) in both outward sides of the trapezoidal groove (11b), the outer diameter roll (12) is provided with a trapezoidal convex portion (13b) corresponding to the trapezoidal groove (11b) of the cored bar roll (11) in a center portion thereof and is provided with holding surfaces (14b) holding the cylindrical member (16) in both outward sides of the trapezoidal convex portion (13b), and is provided with a guide surface (14c) formed in a circular arc shape toward a bottom portion of the outer diameter roll (12) from the holding surface (14b), the cylindrical member (16) pinched between the trapezoidal groove (11b) and the trapezoidal convex portion (13b) is narrowed down by narrowing down the cylindrical member (16) held between holding surfaces (14b) of a pair of bending dies (14) between the outer diameter roll (12) and the cored bar roll (11) so as to narrow down the cylindrical member (16), whereby a thickness in this portion is let out to an outer side and an outer side of the cylindrical member (16) is bent along the guide surface (14c) at the pressing corner portion (11c) serving as a supporting point, and a concave portion (9) is formed in a base end of an annular piece (7) of the finished cage (1) on the way that a thickness movement of the portion pinched between the trapezoidal groove (11b) and the trapezoidal convex portion (13b) moves to an outer side from the bent portion at the pressing corner portion (11c).
